(19) United States
(12) Patent Application Publication
(10) Pub. No.: US 2021/0405268 A1
(43) Pub. Date: Dec. 30, 2021

(54) ULTRA LIGHTWEIGHT TELESCOPE MIRROR BLANK

(71) Applicant: Sergio Ribeiro Cantoli, Dublin, CA (US)

(72) Inventor: Sergio Ribeiro Cantoli, Dublin, CA (US)

(21) Appl. No.: 16/914,359

(22) Filed: Jun. 27, 2020

(51) Int. Cl. G02B 5/08; G02B 7/183; G02B 23/02

(52) U.S. Cl. CPC G02B 5/0833; G02B 23/02; G02B 7/183

(57) ABSTRACT

An ultra lightweight mirror blank having a ribbed back side and a smooth front side. The mirror blank is comprised of a core made of fiber insulation strips, arranged to create a strong ribbed surface on the back of the blank. The core is sandwiched in between two or more plates of fused glass.

### RELATED APPLICATION

Not applicable.

### STATEMENT OF FEDERALITY SPONSORED RESEARCH OR DEVELOPMENT

Not applicable.

### NAME OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTION

Not applicable.

### BACKGROUND

The embodiments herein relate generally to astronomy and the construction of telescopes.

Reflector telescopes are the only option for the most advanced observatories in the world and telescopes in space as well. The most basic types of telescope are called Newtonian, in honor of its inventor, Sir Isaac Newton.

A reflector telescope consists of one larger mirror called a primary and a smaller mirror called secondary. Light coming from distant objects hits the primary mirror, which is concave, and bounces back at an inward angle hitting the secondary mirror.

The secondary mirror is flat and is positioned in an angle of 45 degrees in relation to the primary. The light then is deflected to its final focal point where someone can see the image or install a camera.

Earlier mirrors were made by a reflective metal called speculum. The speculum was polished to achieve reflectivity but it would tarnish quickly and mirrors had to be polished very often.

Glass mirror blanks were created in the mid 19th century using the casting process that allowed polishing to a high quality smooth surface.

In 1856-57 Karl August von Steinheil and Léon Foucault introduced the process of depositing an ultra-thin layer of silver on the front surface of a piece of glass, making the first optical-quality glass mirrors, allowing for advanced studies of the cosmos and replacing forever the use of speculum metal mirrors in reflecting telescopes. Silver was more durable than speculum but will tarnish in a few months.

In the early 1900s mirror makers started coating their mirrors with a thin aluminum layer in a process called vacuum deposition. This aluminizing will last many years.

Currently we have the need for lightweight telescopes to take to space. Due to Earth's gravity, lifting heavy things to space is not an option. Also, amateur astronomers need portable telescopes which can be easily transported to areas with low light pollution and better observing conditions.

Over time, inventors have done many attempts to create lightweight mirrors. This innovative current invention uses hollow space and ribs built to produce a very strong thin wall of fused glass material in a method that is simple to fabricate and low cost.

### SUMMARY

The objective of the present invention is to produce an ultra light mirror blank that has enough strength to prevent it from bending under its own weight. The strength of the blank is due to the ribs on the back of the blank.

Another objective of this invention is to use an extremely lightweight refractory fiber as a core material that doesn't exert any pressure into the walls of the ribs after firing. The strength is achieved purely by the glass walls.

The ultra lightweight telescope mirror has a low cost to fabricate, which is an additional benefit.

Another objective of this invention is to decrease the overall weight of a telescope since the ultra lightweight mirror will require less support to be held inside of the telescope.

The embodiments mentioned herein will become apparent to those skilled in the related art.

### BRIEF DESCRIPTION OF THE DRAWINGS

FIG. 1 is a glass plate illustration of the front face of the mirror blank before assembly and fusing.

FIG. 2 is a core fiber framework.

FIG. 3 is a glass plate illustration of the back of the mirror blank before assembly and fusing.

FIG. 4 is a front face of the mirror blank after fusing.

FIG. 5 is the back of the mirror blank after fusing.

FIG. 6 is a cutaway view of the mirror blank showing the core cavity and glass surface.

FIG. 7 is a cutaway view of the mirror blank as referred in FIG. 6, seen from a different angle.

FIG. 8 is a side view of the mirror blank after fusing and slumping.

### DETAILED DESCRIPTION OF THE INVENTION

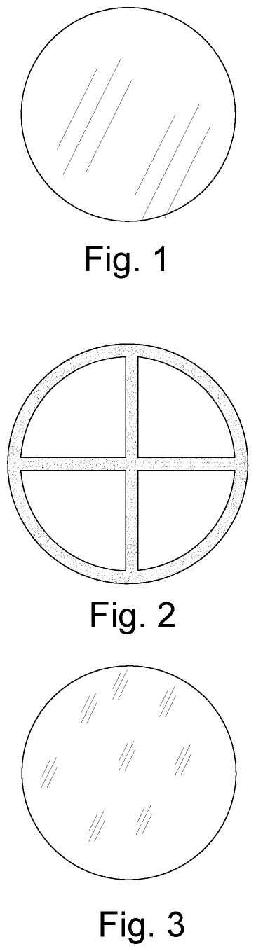

By way of example, one embodiment of a process for producing an ultra lightweight mirror for a telescope includes the following steps. First, cutting two circular discs from a sheet of glass (FIGS. 1 and 3). Cutting fiber spacers from a fiber insulation sheet (FIG. 2). Arranging the fiber spacer strips in between the first circular disc and the second circular disc in order to distribute the ribs' strength across the entire blank. There are several pattern shapes for the ribs that can be used. For example, among others not mentioned here are the popular honeycomb, crisscross and radial-rings combination.

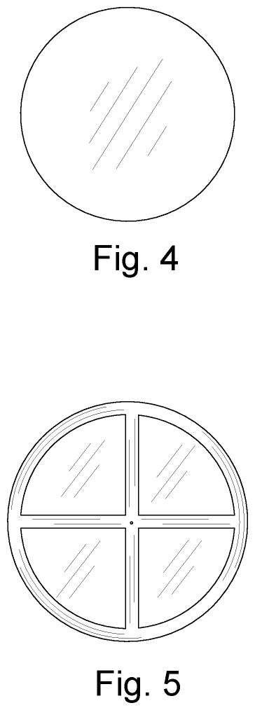

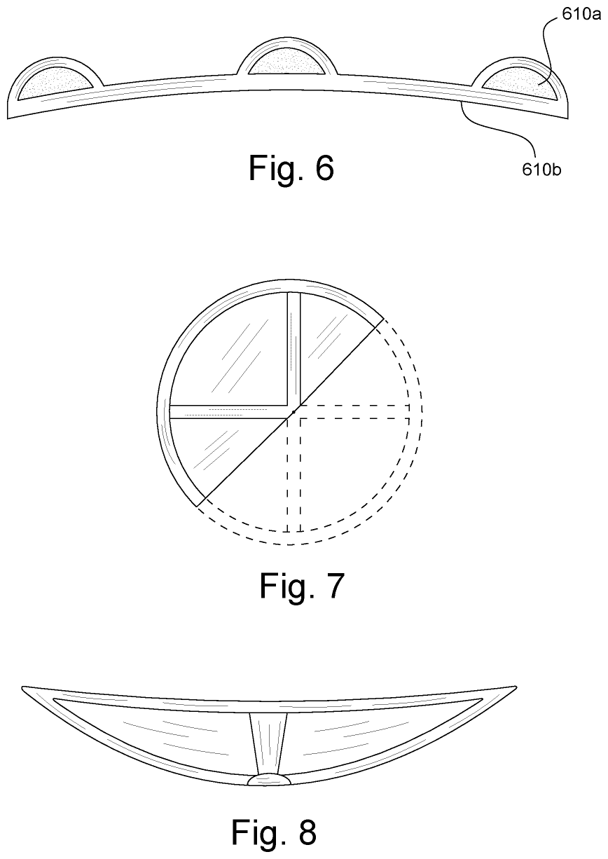

Fuse the core insulation fiber sandwiched in between two or more layers of glass plates to form a fused single piece glass blank (FIGS. 4 and 5). Slump the fused glass blank onto a convex mould to form a concave front side and a convex ribbed back side blank (FIG. 8).

Turning to these steps in more detail, the process to fabricate the ultra lightweight mirror blank starts with a sheet of borosilicate or other low expansion ceramic glass. The material is cut into two or more circle discs (FIGS. 1 and 3) with the desired diameter.

The ceramic core fiber material (FIG. 2) used to create the ribs comes in sheets and needs to be cut in such a way as to create strength evenly across the back surface of the mirror. Several different designs of ribs can be created to achieve an overall strength, for example the one showed on FIG. 2. The diameter of the core fiber sheet should be cut slightly smaller in relation to the glass plates, allowing at least 12 mm overlap of glass throughout the entire edge. Sandwich the glass (FIGS. 1 and 3) and the fiber FIG. 2) with precision to fuse the material. Fuse it in the kiln to the proper temperature and perform the annealing slowly to avoid stress on the glass. The annealing time will depend on the thickness of the blank and the type of glass that is used. If the desired shape is flat then the slump process is not necessary.

For a convex or concave shape (FIG. 8) slump the fused glass. To calculate the curvature of the mould one must multiply the diameter of the mirror (D) by the focal length (FD). To make a concave blank (FIG. 8) the mould should be placed into the kiln with the convex side up and the blank placed on top of the mould with the ribbed side up. The kiln should be fired to the slump temperature and annealed properly to avoid any stress on the glass. Once the slump is completed, the mirror blank is done and the next step is to grind the concave side to a perfectly spherical shape and later to parabolic.

Different types of sliced glass materials can be used to build this invention. Examples include fused silica, fused quartz, ULE by Corning Inc., Zerodur by Schott Germany, any silica based glass or glass ceramic material. The best materials have a very low coefficient of expansion, showing no changes across a wide range of temperatures, such as: ULE by Corning with a coefficient of thermal expansion of about 10-8/K at 5-35° C. Alternatively, Zerodur by Schott with a coefficient of thermal expansion (20° C. to 300° C.): 0.05±0.10×10-6/K.

What is different about the present invention is that these ribs 610a are formed on the back of the mirror blank when the sandwich is fused. They are formed by adding a fiber spacer in between two or more layers of glass plates becoming a sandwich. The sandwich is then fused to become one single piece of glass (FIG. 5) having a fiber core embedded in it 610a. The fiber core can cushion and is flexible, It will not exert any force within the glass ribs. After fusing, the blank is placed on top of a convex mould and heated to the point that the glass becomes soft and slumps on the mould to form a concave or other desired shape. The mirror blank comes out of the oven almost spherical (FIG. 8). This means that the technician may skip the rough grinding needed for traditional mirror blanks, gaining time and leaving fewer scratches on the surface of the mirror. This method also requires much less glass material, lowering the cost of fabrication. Since the present invention is so lightweight, the annealing time is very fast compared to the regular mirrors that can take days or even weeks in the oven to cool down safely.

The newly invented mirror made of a borosilicate sheet or other sliced silica or ceramic material will have no issues with conflicting coefficients of thermal expansion due to different materials since just one type of glass 610b will be used for each mirror and the embedded core material 610a will not exert any pressure into the ribs.

Persons of ordinary skill in the art may appreciate that numerous design configurations can be achieved and the possibility to enjoy the functional benefits of this inventive system. Thus, given the wide variety of configurations and arrangements of embodiments of the present invention, the scope of the invention is reflected by the breadth of the claims below rather than narrowed by the embodiments described above.

What is claimed is:

1. An ultra lightweight mirror blank for a telescope comprising:
a core made of a strip framework of insulating fiber material sandwiched in between a front glass plate and a back glass plate where the sandwich is fused to became one solid single piece having a ribbed back surface and a front surface that can be shaped and polished to achieve an optical reflectivity.

2. An ultra lightweight mirror blank claim 1 wherein the front and back fusible glass plates are made of compound material(s) derived from silica, quartz or ceramic.

3. An ultra lightweight mirror blank claim 2 wherein core fiber can be sandwiched by one or more glass plates on the back or front side.

4. An ultra lightweight mirror blank claim 1 wherein the insulation core material is extremely lightweight, able to cushion and is flexible, for which the choices include but are not limited to mineral wool, ceramic fiber, alumina-silica fiber, carbon fiber, fiber-glass, paper and fiber materials derived from alumina, silica, calcium oxide, magnesium oxide, alkaline earth silicate and ceramics.
